(19) United States
(12) Patent Application Publication
(10) Pub. No.: US 2005/0147192 A1
(43) Pub. Date: Jul. 7, 2005

(54) High frequency signal receiver and semiconductor integrated circuit

(76) Inventors: Akio Yamamoto, Hiratsuka (JP); Yutaka Igarashi, Yokohama (JP); Isao Ikuta, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/985,948

(22) Filed: Nov. 12, 2004

(30) Foreign Application Priority Data
Nov. 13, 2003 (JP) 2003-383659

(51) Int. Cl. H04L 27/08

(52) U.S. Cl. 375/345; 375/350

(57) ABSTRACT

A high frequency signal receiver comprising a variable gain amplifier, a first filter for restricting a bandwidth of an analog baseband signal, an AD converter connected to the first filter, a second filter for restricting the bandwidth of an output of the AD converter, an interference wave detection circuit for detecting the level of an interference wave in the received signal, and a controller for controlling the first filter to have a wide bandwidth when the level of the interference wave is lower than a threshold level, and switching the first filter to have a narrow bandwidth while changing the characteristics of the second filter so as to compensate deterioration of the pass-band of the first filter when the level of the interference wave is equal to or greater than the threshold level.

### BACKGROUND OF THE INVENTION

(1) Field of the Invention

The present invention relates to a high frequency signal receiver and a semiconductor integrated circuit, and more particularly to a high frequency signal receiver and a semiconductor integrated circuit, e.g. a mobile terminal, which receives a digitally modulated high-frequency signal and converts the signal into a baseband signal.

(2) Description of Related Art

In Europe, etc., GSM is quite popular as a radio communication system for cellular phone. In Japan, a WCDMA proposed as the third-generation system begins to be used. A communication service using the GSM system has started operations in the 900 MHz band. As the number of subscribers increases thereafter, the frequency band has been extended. Recently, multiband cellular phones that can perform communications in the 1800 MHz band and 1900 MHz band are available. On the other hand, the transmission/reception standard for the WCDMA system (WCDMA 2000) is defined in 3GPP (3-rd Generation Partnership Project), and 2000 MHz band in ranges from 1920 MHz to 1980 MHz and 2110 MHz to 2170 MHz is used as its transmission/reception band.

Reception circuits of cellular phones according to the GSM system or WCDMA system adopt a direct conversion capable of converting a received RF signal into an IQ signals in the baseband directly, as described in some documents, for example, “A Single-Chip Quad-Band Direct-Conversion GSM/GPRS RF Transceiver with Integrated VC02 and Fractional-N Synthesizer” in ISSCC 2002, 14.2 (non-patent document 1), and U.S. Pat. No. 5,483,691 titled “ZERO INTERMIDIATE FREQUENCY RECEIVER HAVING AN AUTOMATIC GAIN CONTROL CIRCUIT” (Patent Document 1).

To suppress an interference wave such as an adjacent channel frequency, etc., a reception circuit of the direct conversion type includes a low-pass filter LPF (hereinafter referred to as an analog filter) for restricting a bandwidth of an analog baseband signal, an AD converter for converting an analog signal passed through the analog filter into a digital filter, and a FIR filter (hereinafter referred to as a digital filter) located in a post-stage of the AD converter. The output signal of the digital filter is input to a demodulation circuit.

That is, since it is difficult for the analog filter comprising resister elements and capacitor elements to have a sharp cutoff frequency, the direct conversion type reception circuit removes a part of the interference wave by an analog filter (a first filter) and removes the remaining interference wave by using a digital filter (a second filter) obtainable a sharp characteristic by setting tap coefficients.

The digital filter can output a signal of a desired channel only without any interference wave. In the reception circuit of the direct conversion type, the input signal level of the AD converter or the demodulator is optimized by detecting the output signal of the digital filter and controlling the gain of the reception system so that the level of the detection signal becomes constant. Further, the level of the desired signal is controlled in such a manner that the AD converter does not get saturated by the remaining interference wave at the input.

In the WCDMA system according to the 3GPP reception unit standard (3GPP TS25.101 V5.3.0 (2002-06)), the bandwidth is 5 MHz and the transmission chip rate is 3.84 MHz in each channel. Band 1 (2.11 GHz to 2.17 GHz), band 2 (1.93 GHz to 1.99 GHz) and band 3 (1.805 GHz to 1.88 GHz) are defined as reception bands, and different reception bands are assigned to different areas.

The band 2 and band 3 overlap with an occupied band in the GSM system. Thus, the 3GPP reception unit standard defines narrow band blocking treating a GSM signal as an interference wave. It estimates an interference wave considerably approximate a desired signal frequency whose offset frequency from the core frequency of a WCDMA signal is 2.7 MHz. With respect to band 1, since the bandwidth is away from the occupied band in the GSM system, the interference wave of the adjacent channel having the offset frequency of 5 MHz is defined, but the adjacent interference wave, such as narrow band blocking, etc. is not defined at all.

In the case of the direct conversion system, it is necessary to suppress the adjacent channel interference or the narrow band blocking, using an analog filter for a baseband signal. In this case, when suppressing the interference wave (the narrow band blocking, etc.) adjacent to the desired signal frequency, an analog filter having a multi-level structure in a high order is needed. In this structure, problems are the increased size of the reception circuit and deterioration of the phase characteristic.

### SUMMARY OF THE INVENTION

Normally, the bandwidth of an analog filter to be used for restricting a bandwidth of a baseband signal is designed to passes a desired signal and to fully suppress an adjacent channel signal. When receiving, for example, a band 1 signal in the WCDMA, the cutoff frequency of the analog filter is set at approximately 2.4 MHz (herein after referred to as a “wide bandwidth”), so that a signal at a baseband up to 1.92 MHz can pass with a flat characteristic, and the signal of an adjacent channel in the range from 3.08 MHz to 6.84 MHz can be suppressed approximately in the range from 20 dB to 30 dB.

However, in the narrow band blocking in the band 2 in the WCDMA, since the frequency of the interference wave approximates the desired signal frequency whose offset frequency is 2.7 MHz, it is impossible to suppress the interference wave by the analog filter having the cutoff frequency of 2.4 MHz. Therefore, according to the conventional gain control described above, the input signal level of the AD converter located in the post stage of the analog filter increases, and the reception characteristic may possibly be deteriorated due to saturation.

In order to remove the interference wave component, such as narrow band blocking, etc. having the approximate frequency, if the analog filter is configured to have a bandwidth (hereinafter referred to as a “narrow bandwidth”), i.e. a cutoff frequency of 1.8 MHz, for example, the baseband signal at 1.92 MHz does not have a flat pass characteristic, resulting in deterioration of the signal-to-noise ratio (SNR).

It is accordingly an object of the present invention to provide a high frequency signal receiver and a semiconductor integrated circuit which can preferably receive a desired signal, even if there exists an interference wave, such as narrow band blocking, etc. near a desired signal frequency.

The analog filter can suppress the interference wave in the adjacent channel, but can't suppress the interference component such as the narrow band blocking at a frequency near the desired frequency. Accordingly, unless there exists any interference wave such as the narrow band blocking at the approximate frequency during signal reception, the signal level (first detection signal level) of output of an AD converter for digitizing the output of the analog filter approximately coincides with the output signal level (second detection signal level) of a digital filter connected in a post stage of the AD converter. If there exists an interference wave such as the narrow band blocking at the approximate frequency during the signal reception, since the analog filter can't suppress the frequency component of the interference wave, it results in an increase in the output signal level of the AD converter. In contrast, the digital filter can remove such an approximate frequency component as the narrow band blocking, the interference wave has no effect on the output level of the digital filter.

The present invention has been made in consideration of the above-described different characteristic of the analog filter and the digital filter. One feature of the present invention is to detect whether there exists an interference signal such as the narrow band blocking interference at an approximate frequency, by comparing the output signal level (the first detection signal level) of the AD converter with the output signal level (the second detection signal level) of the digital filter, and checking whether a level difference between the compared signals is grater than a predetermined threshold value.

In a high frequency signal receiver according to the present invention, when an interference wave at a frequency near the desired signal is detected, a controller narrows the bandwidth of an analog filter to remove the interference component. In this case, there is a possibility that the pass characteristic of the baseband signal to be received becomes non-flat, and the SNR may possibly be deteriorated. Another feature of the present invention is to change the pass-band characteristic of a post-stage digital filter so that the deterioration of the pass characteristic of the baseband signal is compensated.

In addition, upon reception of an interference signal, e.g. the narrow band blocking interference, having a frequency near the desired signal, there is a possibility of saturating the AD converter due to the raised output level of the analog filter. In order to prevent the AD converter from being saturated, the high frequency signal receiver of the present invention controls the gain of a reception amplifier located in the pre-stage of the analog filter according to the output signal level of the digital filter as a control target when no interference signal exists, and controls the gain of the reception amplifier according to the output signal level of the AD converter as a control target when an interference wave is detected.

According to still another feature of the high frequency signal receiver of the present invention, besides a reception circuit for receiving the desired signal, a second reception circuit for receiving a signal from another communication system which is different from the desired signal is provided as an interference wave detection means for detecting an interference wave, which can not be suppressed by the analog filter and has a frequency near the desired signal frequency. Whether there exists an interference wave is detected based on an output signal (demodulated signal) from the second reception circuit. For example, in a WCDMA/GSM dual mode receiver, the GSM receiver is operated in a compressed mode during reception of a WCDMA signal, and the existence of an interference GSM signal having a frequency near the WCDMA received signal (desired signal) is detected based on the output of the GSM receiver.

A semiconductor integrated circuit according to the present invention comprises: a low noise amplifier for amplifying a received high frequency signal; a pair of mixers for I-phase (Inphase) and Q-phase (Quadraphase) connected to the low noise amplifier; a 90-degree phase shifter for generating two series of oscillation signals for I-phase and Q-phase from an output signal of an oscillator, and supplying the mixers with the generated signals; variable gain amplifiers for I-phase and Q-phase connected to the mixers, respectively; and a pair of analog filters for I-phase and Q-phase connected to the variable gain amplifiers, respectively. Each of the analog filters is configured to have a wide bandwidth for passing a baseband signal of a desired wave with a flat characteristic or a narrow bandwidth for suppressing an interference wave near the desired wave, in accordance with a switching control signal externally given.

In the high frequency signal receiver according to the present invention, the controller determines a level of the interference wave in the received signal based on an output signal from the interference wave detection circuit, controls an AD converter to operate in a predetermined dynamic range when the level of the interference wave in the received signal is lower than the predetermined level, and controls the AD converter to have a wide dynamic range when the level of the interference wave in the received signal is equal to or greater than the predetermined level.

In the high frequency signal receiver according to the present invention, the controller determines a level of the interference wave in the received signal based on an output signal from the interference wave detection circuit, and controls the first filter to operate in a predetermined bandwidth and the AD converter to operate in a predetermined dynamic range when the level of the interference wave in the received signal is lower than a predetermined level. When the level of the interference wave in the received signal is equal to or greater than the predetermined level, the controller controls the first filter to have a narrow bandwidth, the AD converter to have a wide dynamic range and the pass-band characteristic of the second filter so that deterioration of the pass-band characteristic of the first filter can be compensated.

According to an embodiment of the present invention, the high frequency signal receiver is provided with a pair of AD converters each for converting an analog signal output from the first filter into a digital signal and including a first AD converter having a wide dynamic range and a second AD converter having a narrow dynamic range. In this case, the controller determines the level of an interference wave in the received signal based on an output signal from the interference wave detection circuit, controls the AD converter so that the first AD converter having the wide dynamic range is operative when the level of the interference wave in the received signal is lower than the predetermined level, and controls the AD converter so that the second AD converter having the narrow dynamic range is operative when the level of the interference wave in the received signal is equal to or greater than the predetermined level.

According to the present invention, even in the case where the interference wave, e.g. the narrow band blocking interference, having a frequency near the desired signal frequency is received, the input level of the AD converter can be optimized by changing the bandwidth of the analog filter, or switching the control target in the gain control. Therefore, the present invention can preferably receive the desired signal even if a large amount of interference wave component exists.

### BRIEF DESCRIPTION OF THE DRAWINGS

FIG. 1 is a block diagram showing the first embodiment of a receiver according to the present invention.

FIG. 2 is a flowchart for explaining a filter control routine executed by a controller 17 in the receiver of the first embodiment.

FIG. 3 is a block diagram showing the second embodiment of a receiver according to the present invention.

FIG. 4 is a flowchart for explaining a gain control routine executed by a controller 17 in the receiver of the second embodiment.

FIG. 5 is a block diagram showing the third embodiment of a receiver according to the present invention.

FIG. 6 is a block diagram showing the fourth embodiment of a receiver according to the present invention.

FIG. 7 is a block diagram showing the fifth embodiment of a receiver according to the present invention.

FIG. 8 is a block diagram showing the sixth embodiment of a receiver according to the present invention.

FIG. 9 is a block diagram showing the seventh embodiment of a receiver according to the present invention.

FIG. 10 is a block diagram showing the eighth embodiment of a receiver according to the present invention.

FIG. 11 is a block diagram showing the ninth embodiment of a receiver according to the present invention.

FIG. 12 is a block diagram showing the tenth embodiment of a receiver according to the present invention.

FIG. 13 is a block diagram for additionally explaining the first embodiment of the receiver according to the present invention.

### DESCRIPTION OF THE PREFERRED EMBODIMENTS

Preferred embodiments of the present invention will now be explained with reference to the accompanying drawings.

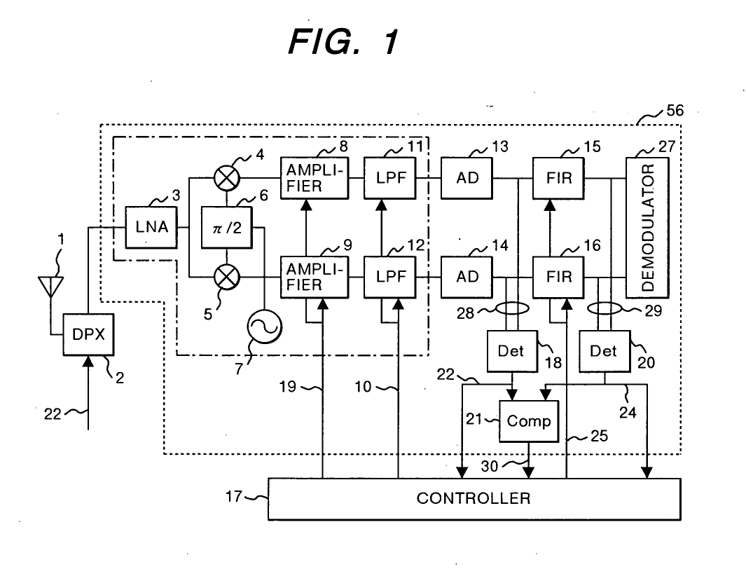

FIG. 1 shows the first embodiment of a high frequency receiver according to the present invention. The high frequency receiver of the present invention comprises a duplexer (DPX) 2 connected to an antenna 1 for separating a transmission signal and received signal, a reception system circuit 56 and a controller (processor) 17. The duplexer 2 is connected to a transmission system circuit so as to receive an output signal 22 from the transmission system. However, since the transmission system circuit has no relation to the present invention, it is omitted from the illustration.

The reception system circuit 56 has a low noise amplifier (LNA) 3 connected to the duplexer 2, mixers 4 and 5 connected to the LNA 3, a 90-degree phase shifter 6, variable gain amplifiers 8 and 9 for Inphase and Quadraphase connected to the mixers 4 and 5, respectively, analog filters (LPF) 11 and 12 for Inphase and Quadraphase connected to the variable gain amplifiers 8 and 9, respectively, AD converters (ADC) 13 and 14 for Inphase and Quadraphase connected to the analog filters 11 and 12, respectively, digital filters 15 and 16 for Inphase and Quadraphase connected to the AD converters 13 and 14, respectively, and a demodulator 27 connected to the digital filters 15 and 16. The 90-degree phase shifter 6 generates oscillation signals of two series for Inphase and Quadraphase from an output signal of an oscillator (VCO) 7, and supplies the mixers 4 and 5 with the generated oscillation signals. In the illustration, a circuit block enclosed with a dot and dash line can be provided as a semiconductor integrated circuit device. In other embodiments as will be described later, a semiconductor integrated circuitry portion will be indicated in the same manner.

In the receiver of this embodiment, the reception system circuit 56 further includes a first detector 18, a second detector 20 and a comparator 21. The first detector 18 detects the level of Inphase and Quadraphase digital signals 28 output from the AD converters 13 and 14. The second detector 20 detects the level of Inphase and Quadraphase digital signals 29 output from the digital filters 15 and 16. The comparator 21 compares a level detection signal 22 output from the first detector 18 and a level detection signal 24 output from the second detector 20. The controller 17 changes characteristics of the variable gain amplifiers 8 and 9, the analog filters (LPF) 11 and 12 and the digital filters 15 and 16, based on the level detection signals 22 and 24 and an output signal 30 of the comparator 21.

In the receiver, a radio high frequency signal (RF signal) received by the antenna 1 is input to the reception system circuit 56 through the duplexer 2, and is amplified by the low noise amplifier 3. This amplified signal is supplied to the mixers 4 and 5. Each of the mixers 4 and 5 performs orthogonal detection on the received signal with an oscillation signal from the 90-degree phase shifter 6, and converts the signal into an I-phase reception signal and a Q-phase reception signal. The gain of the I-phase signal is adjusted with the variable gain amplifier 8. After removing any unnecessary signal component by the filter 11, the I-phase signal is converted into a digital signal by the AD converter 13. Similarly, the gain of the Q-phase signal is adjusted with the variable gain amplifier 9, and unnecessary signal component is removed from the Q-phase by the filter 12. Then, the Q-phase signal is converted into a digital signal by the AD converter 14. The I-phase digital signal and the Q-phase digital signal output from the AD converters 13 and 14 are supplied to the digital filters 15 and 16, respectively, thereby to suppress any unnecessary wave and to shape their waveform. Then, those digital signals are input to the demodulator 27.

In this embodiment, the first detector 18 detects the level of the I-phase and Q-phase digital signals 28 output from the AD converters 13 and 14. Similarly, the second detector 20 detects the level of the I-phase and Q-phase digital signals 29 output from the digital filters 15 and 16. The first level detection signal 22 output from the first detector 18 and the second level detection signal 24 output from the second detector 20 are input to the controller 17 and the comparator 21. The comparator 21 generates a signal 30 indicating whether the difference between the first and second level detection signals exceeds a predetermined threshold value, and inputs the generated signal to the controller 17.

The controller 17 generates a gain control signal 19 for the variable gain amplifiers 8 and 9 according to the first level detection signal 22 or the second level detection signal 24. The controller 17 generates a bandwidth control signal 10 for the analog filters 11 and 12 as well as a pass-band characteristic control signal 25 for the digital filters 15 and 16 according to the comparator-output signal 30.

Normally, the bandwidth of each of the analog filters 11 and 12 is selected so as to pass the desired signal and to suppress adjacent channel signals. For example, when receiving a signal of WCDMA band 1, the cutoff frequency of the analog filter is set approximately at 2.4 MHz (hereinafter referred to as a “wide bandwidth”) so that signals in the baseband width of 1.92 MHz can pass through with a flat characteristic, and the adjacent channel signals in the range from 3.08 MHz to 6.84 MHz are suppressed approximately in the range from 20 dB to 30 dB. In this case, the interference waves of the adjacent channel signals, etc. are sufficiently suppressed by the analog filters 11 and 12. Hence, the level of output signals (the first level detection signal 22) of the AD converters 13 and 14 detected by the first detector 18 coincides approximately with the level of output signals (the second level detection signal 24) of the digital filters 15 and 16 detected by the second detector 20. Note that the cutoff frequency of 2.4 MHz is one example as the wide bandwidth, and the cutoff frequency may be set at any other MHz.

The narrow band blocking of band 2 in the WCDMA acts as an interference wave whose offset frequency is 2.7 MHz. Such an interference wave is not fully suppressed by the above-described analog filters having the cutoff frequency of 2.4 MHz. Therefore, the output signal level of the AD converters 13 and 14 becomes greater than the level observed during the reception of a band 1 signal, due to the effect of the narrow band blocking. In contrast, the digital filters 15 and 16 can eliminate adjacent interference waves such as narrow band blocking, etc. Thus, the output signal level of the digital filters 15 and 16 is lower than that of the AD converters 13 and 14. For these reasons, a certain difference greater than a predetermined value occurs between the first level detection signal 22 and the second level detection signal 24.

In this embodiment, the controller 17 determines whether any interference wave such as narrow band blocking interference having the adjacent frequency is received, based on the above difference between the first and second level detection signals. In the case where the interference wave having the adjacent frequency is received, that is, when the output signal 30 of the comparator 21 indicates that the difference between the first and second level detection signals is greater than a predetermined value, the controller 17 switches the bandwidth of the analog filters 11 and 12 to a bandwidth (hereinafter referred to as a “narrow bandwidth”) lower than the cutoff frequency 2.4 MHz, for example, lower than 1.8 MHz. Note that the frequency of 1.8 MHz is one example as the narrow bandwidth, and the frequency may be set at any other MHz.

In this manner, if the analog filters 11 and 12 are set to have a narrow bandwidth, there is possibility that the flat baseband pass characteristic of 1.92 MHz is deteriorated, and SNR is lowered. In this embodiment, therefore, the pass-band characteristic of the digital filters 15 and 16B located in the post stage is changed by the controller 17 in conjunction with the switching of the bandwidth of the analog filters 11 and 12, thereby compensating for the bandwidth deterioration.

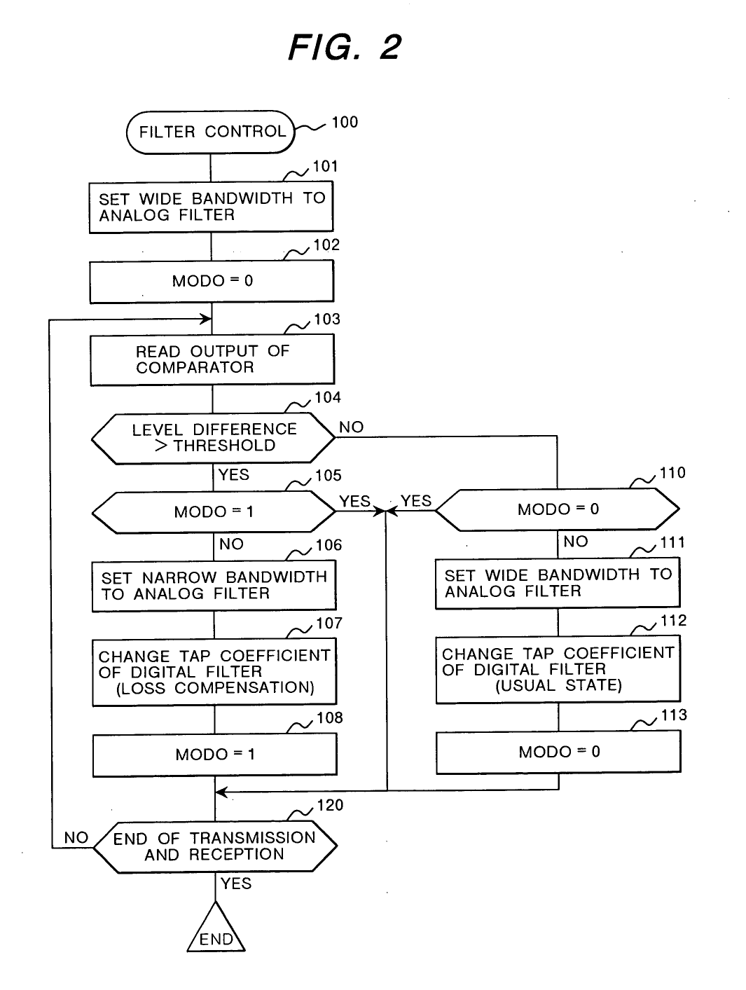

FIG. 2 shows a flowchart of a filter control routine 100 executed by the controller 17.

At the time the transmission/reception system begins operations, the controller 17 sets the cutoff frequency of the analog filters 11 and 12 at a wide bandwidth (Step 101), sets an operation mode parameter (MODE) to “0” (Step 102), and reads out the output signal 30 of the comparator 21 (Step 103). In the case where the output signal 30 of the comparator 21 indicates that a signal level difference between the first level detection signal 22 and the second level detection signal 24 is equal to or less than a predetermined threshold value (Step 104), the controller 17 determines that there is no interference wave near the desired wave. In this case, the controller 17 checks whether the parameter MODE is “0” (Step 110). If the parameter MODE=“0”, the controller 17 checks whether transmission/reception processing is completed (Step 120). If the transmission/reception processing is completed, the controller 17 terminates this control routine. If the transmission/reception processing has not been completed yet, the control sequence returns to Step 103 so as to repeat the same processing.

In the case where MODE=1 in Step 110, the controller 17 sets the cutoff frequency of the analog filters 11 and 12 to a wide bandwidth (Step 111), and resets the tap coefficients of the digital filters 11 and 12 to a normal state (Step 112). Then, the controller 17 sets the parameter MODE to “0” (Step 113), and checks whether the transmission/reception processing has been completed (Step 120).

In the case where the signal level difference between the first level detection signal 22 and the second level detection signal 24 is greater than the predetermined threshold value in Step 104, it is determined that interference wave near the desired signal frequency is received. In this case, the controller 17 checks whether the parameter MODE is “1” (Step 105). If the parameter MODE is “1”, the controller 17 checks whether the transmission/reception processing has been completed (Step 120). In the case where the transmission/reception processing has been completed, the controller 17 terminates this control routine. Otherwise, the control sequence returns to Step 103.

In the case where the parameter MODE is “0” in Step 105, the controller 17 sets the cutoff frequency of the analog filters 11 and 12 to a narrow bandwidth (Step 106), and changes the tap coefficients of the digital filters 15 and 16, thereby compensating for the loss of baseband occurred in the analog filters 11 and 12, using the digital filters (107). After this, the controller 17 sets the parameter MODE to “1” (Step 108), and checks whether the transmission/reception processing has been completed (Step 120). If the transmission/reception processing has been completed, the controller 17 terminates this control routine. Otherwise, the control sequence returns to Step 103.

Note that the sequence of Steps 103 to 113 may be executed periodically at predetermined intervals. In this embodiment, the controller 17 determines whether the difference between the first level detection signal 22 and the second level detection signal 24 is greater than the predetermined threshold value, based on the status the output signal 30 of the comparator 21. However, the comparator 21 may be excluded from the reception system 56. In this case, instead of the comparator 21, the controller 17 may read out the value of the first level detection signal 22 and the second level detection signal 24 in Step 103, compare the read values, and determine whether the level difference is greater than the predetermined threshold value.

According to this embodiment, when an interference wave near the adjacent signal frequency is received, the input level of the AD converters can be optimized by switching the bandwidth of the analog filters from a wide bandwidth to a narrow bandwidth, and the deterioration of the baseband pass characteristic in the analog filters can be compensated using the digital filters located in the post stage, thereby realizing preferable reception characteristics.

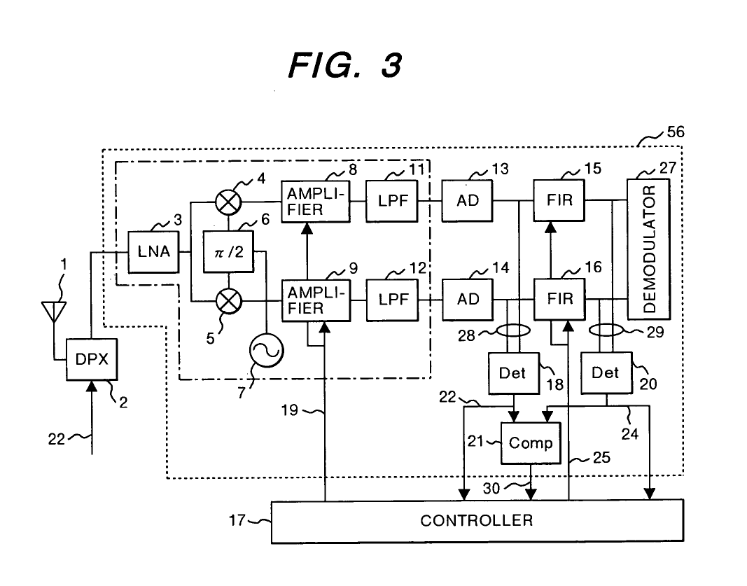

FIG. 3 shows the second embodiment of a receiver according to the present invention. In FIG. 3, since the same reference numerals are applied for the same blocks as those described in the first embodiment, the same operations that have already been described in the first embodiment will be omitted from the explanation.

In the second embodiment, like the first embodiment, the controller 17 determines whether an interference wave such as the narrow band blocking interference, etc. near the desired signal frequency is received, based on the output signal 30 from the comparator 21 using the difference between the first level detection signal 22 and the second level detection signal 24.

In the case where it is determined that there is no interference wave near the desired signal frequency, the controller 17 generates a gain control signal 19 for the gain control amplifiers 8 and 9 such that the output level of the digital filters 15 and 16 (the second level detection signals) keeps a desired value (control target). At this time, each of the outputs of the digital filters contains only a desired channel signal without any interference wave component. Therefore, the input signal level of the AD converters 13 and 14 or the demodulator 27 can be optimized by controlling the gain of the gain control amplifiers 8 and 9, so that the output level of the digital filters (the second level detection signals) keeps a predetermined level. In this case, each of the input signals of the AD converters 13 and 14 includes a remaining interference wave or peak factor component in addition to a desired signal wave having a predetermined level. Thus, the control target of the output level of the digital filters is set to such a level that the AD converters 13 and 14 does not get saturated by the remaining interference wave.

In the case where it is determined that there exists an interference wave near the desired signal frequency based on the output signal 30 of the comparator 21, the controller 17 generates a gain control signal 19 for the gain control amplifiers 8 and 9, using the first detection signal 22 indicating the input signal level of the digital filters 15 and 16 as a control target. At this time, each of the input signals of the digital filters 15 and 16 includes the adjacent interference wave and the remaining interference wave besides the desired signal. Therefore, by controlling the gain of the gain control amplifiers 8 and 9 so that the first detection signal 22 keeps the target level, it is able to prevent the input signal of the AD converters from being saturated and to reduce the characteristic deterioration even if there exists a large amount of interference wave component.

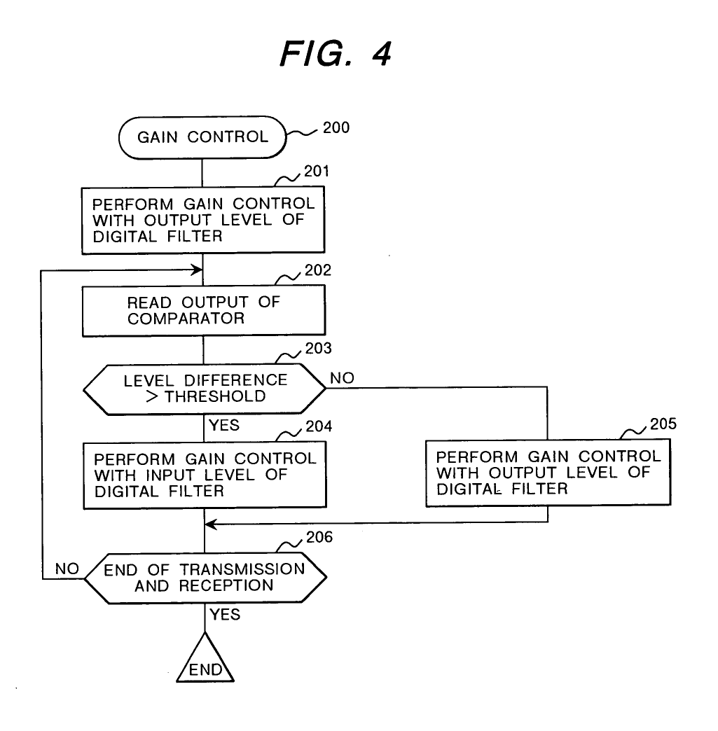

FIG. 4 shows a flowchart of a gain control routine 200 to be executed by the controller 17 in the second embodiment.

At the time the transmission/reception system begins operations, the controller 17 performs gain controlling in such a manner that the second level detection signal 24 output from the second detector 20 reaches a predetermined level (Step 201), and reads out the value of the output signal 30 from the comparator 21 (Step 202). In the case where the output signal 30 indicates that the difference between the first level detection signal 22 and the second level detection signal 24 is greater than a predetermined threshold value (Step 203), the controller 17 determines that an interference wave is received. Then, the controller 17 changes the control target, and performs the gain controlling in such a manner that the first level detection signal 22 output from the first detector 18 keeps a predetermined level (Step 204). After that, the controller 17 checks whether the transmission/reception processing has been completed (Step 206). If the transmission/reception processing has been completed, the controller 17 terminates this control routine. Otherwise, the control sequence returns to Step 202.

In Step 203, in the case where the output signal 30 indicates that the difference between the first level detection signal 22 and the second level detection signal 24 is equal to or less than the predetermined threshold value, the controller 17 determines that there is no interference wave near the desired signal frequency. Then, the controller 17 performs gain control in such a manner that the second level detection signal 24 output from the second detector 20 keeps a predetermined level (Step 205). After that, the controller 17 determines whether the transmission/reception processing has been completed (206). If the transmission/reception processing has been completed, the controller 17 terminates this control routine. Otherwise, the control sequence returns to Step 202.

Note that the sequence of Steps 202 to 206 may be executed periodically at predetermined interval. The comparator 21 may be excluded from the reception system 56. In this case, the controller 17 reads out the values of the first level detection signal 22 and the second level detection signal 24 in Step 202, compares the read values, and determines whether the level difference is greater than a predetermined threshold value.

According to the second embodiment, when the adjacent interference wave is received, the controller 17 performs the gain controlling using a detection output including the interference wave component. Thus, the input of the AD converters can be prevented from being saturated and the characteristic deterioration can be suppressed even in the case where there exists a large amount of interference wave component.

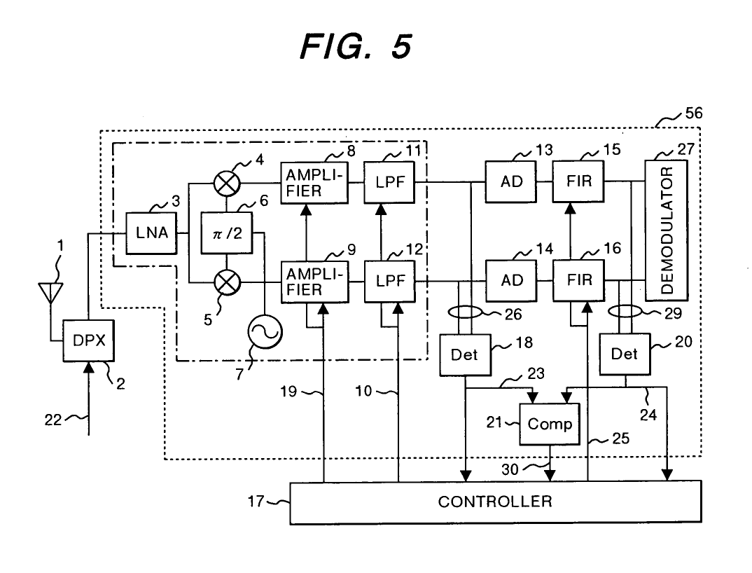

FIG. 5 shows the third embodiment of a receiver according to the present invention. In FIG. 5, the same reference numerals are applied for the same blocks as those described in the first embodiment. The explanation that overlaps the first embodiment will be omitted.

Unlike the first embodiment, in the third embodiment, the first detector 18 detects the level of I-phase and Q-phase signals 26 input to the AD converters 13 and 14. Then, the comparator 21 compares a first level detection signal 23 output from the first detector 18 and the second level detection signal 24 output from the second detector 20, and generates a signal 30 indicating whether the difference between the compared first and second level detection signals is greater than a predetermined value.

Like the first embodiment, according to this embodiment, when an interference wave near the desired signal frequency is received, the input level of the AD converters can be optimized by narrowing the bandwidth of the analog filters, and preferable reception characteristic is available by compensating the deterioration of the baseband pass characteristic in the analog filters using the digital filters located in the post stage.

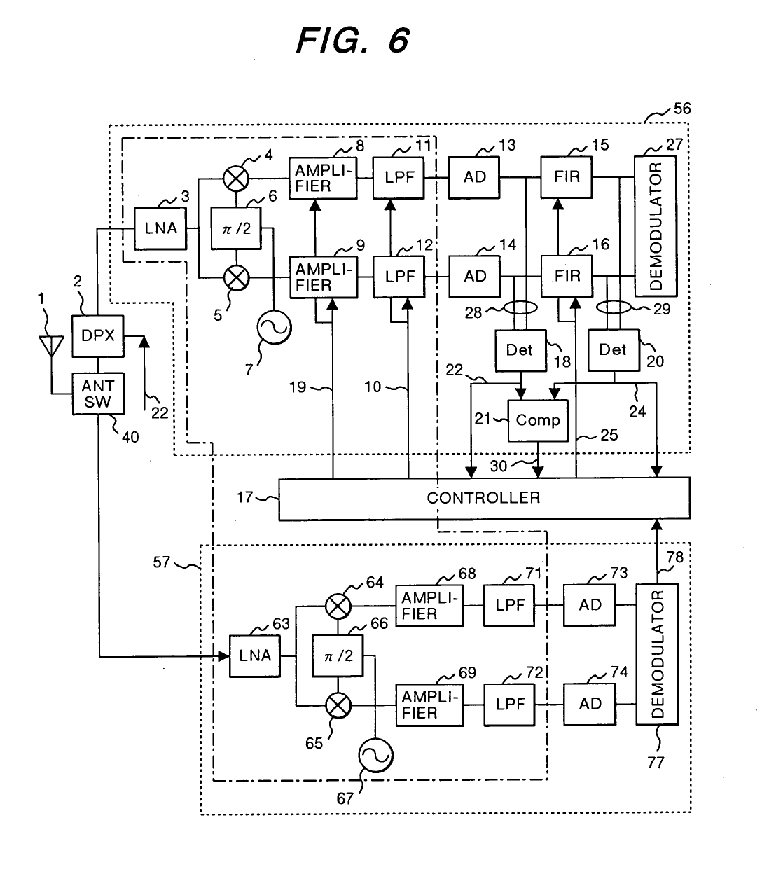

FIG. 6 shows the fourth embodiment of a receiver according to the present invention. The same reference numerals are applied for the same blocks as those described in the first embodiment. The explanation that overlaps the first embodiment will be omitted.

The fourth embodiment is characterized in that the receiver includes a second reception system 57 in addition to the reception system 56 described in the first embodiment, and the existence of an interference wave near the desired signal is detected with this second reception system 57. The second reception system 57 is connected to the antenna 1 through an antenna switch 40 together with the duplexer 2 connected to the reception system 56.

The second reception system 57 comprises a low noise amplifier 63 connected to the antenna switch 40, direct conversion mixers 64 and 65 for I-phase and Q-phase, a 90-degree phase shifter 66, an amplifier 68, a low-pass filter 71 and an AD converter 73 to process the output signal of the mixer 64 for I-phase, an amplifier 69, a low-pass filter 72 and an AD converter 74 to process the output signal of the mixer 65 for Q-phase, and a demodulator 77 to which output signals from the AD converters 73 and 74 are supplied 90-degree phase shifter 66 generates oscillation signals of two series for I-phase and Q-phase from an output signal of an oscillator 67, and supplies the mixers 64 and 65 with the generated signals, respectively.

The reception systems 56 and 57 receive signals of communication systems different from each other. For example, the reception system 56 receives signals in the WCDMA system, whereas the reception system 57 receives signals in the GSM system. The receiver according to this embodiment detects the existence of the interference wave for the reception system 56 using the second reception system 57, in the case where the interference wave near the desired signal frequency of the reception system 56 is received as a desired signal for the second reception system 57.

The controller 17 monitors a demodulated signal 78 output from the demodulation circuit 77 in the second reception system 57 and determines whether an interference wave exists near the desired signal frequency of the reception system 56 based on the status of the demodulated signal 78. In the case where the interference wave is detected, the controller 17 sets the analog filters 11 and 12 in the reception system 56 to have a narrow bandwidth, thereby eliminating the effect of the interference wave, like the case of the first embodiment. Further, the controller 17 changes the tap coefficients of the digital filters 15 and 16 located in the post stage, thereby compensating for the deterioration of the band characteristic in the analog filters 11 and 12. In the case where it is judged that there is no interference wave near the desired signal frequency of the reception system 56 based on the status of the demodulated signal 78, the controller 17 sets the analog filters 11 and 12 to have a wide bandwidth, and continues operations for reception.

According to the fourth embodiment, like the first embodiment, when an interference wave near the desired signal frequency is received, the input level of the AD converters can be optimized, and the deterioration of the baseband pass characteristic in the analog filters 11 and 12 can be compensated using the digital filters located in the post stage, thereby realizing preferable reception characteristics.

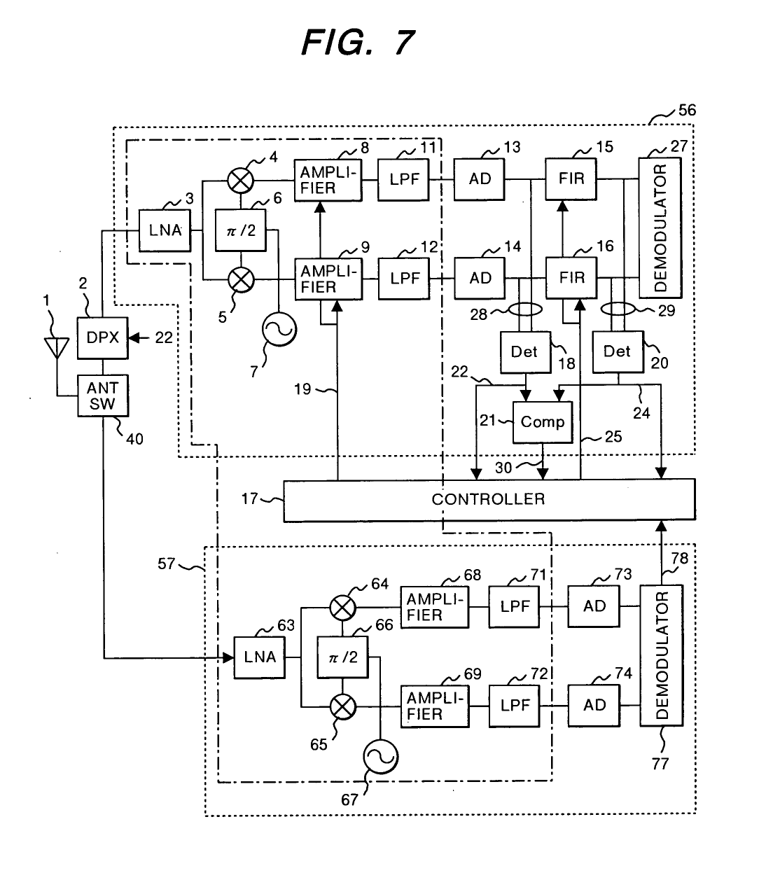

FIG. 7 shows the fifth embodiment of a receiver according to the present invention.

Like the fourth embodiment, the receiver of this embodiment detects the existence of the interference wave near the desired signal frequency by using the second reception system 57. In the case where a signal used in the second reception system 57 acts as an interference wave near the desired signal frequency on the reception system 56, the controller 17 can detect the interference wave based on the status of the demodulated signal 78 of the reception system 57.

In this embodiment, in the case where it is judged that there is no interference wave near the desired signal frequency based on the status of the demodulated signal 78 of the reception system 57, the controller 17 controls the gain of the gain control amplifiers 8 and 9 so that the second level detection signal output from the second detector 20 keeps a target level, like the case of the second embodiment.

On the other hand, in the case where it is judged that there exists an interference wave near the desired signal frequency, the controller 17 switches the control target. Specifically, the controller 17 controls the gain of the gain control amplifiers 8 and 9 so that the first level detection signal 22 from the first detector 18 keeps a predetermined target level.

Like the second embodiment, according to the receiver of the fifth embodiment, the characteristic deterioration can be reduced while the input of the AD converters is prevented from being saturated, even if there exists a large amount of interference wave component.

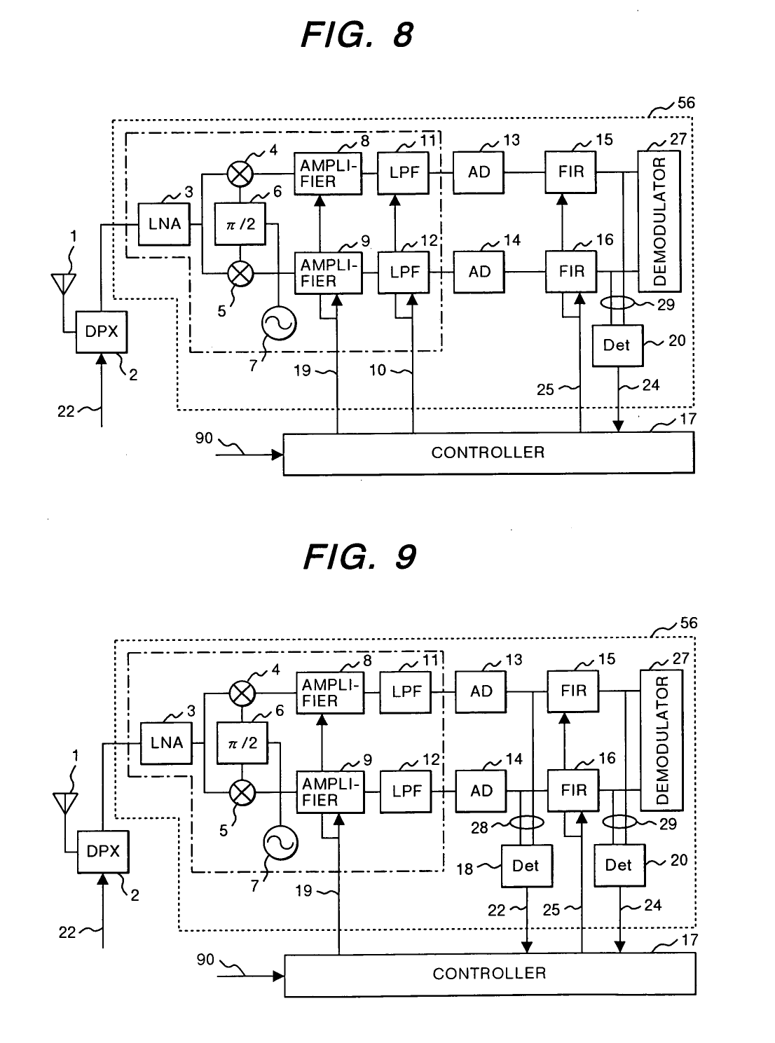

FIG. 8 shows the sixth embodiment of a receiver according to the present invention. Since the same reference numerals are applied for the same blocks as those described in the first embodiment, the explanation that overlaps the first embodiment will be omitted.

The receiver of this embodiment is designed for the WCDMA cellular phone system in the 3GPP standard, for example, and the first detector 18 and the comparator 21 of the first embodiment are removed.

In the WCDMA cellular phone system, the interference wave such as the narrow band blocking interference having the adjacent frequency of the desired signal is received only during the reception for the operating band 2 or 3. The controller 17 of this embodiment sets up the analog filters to have a wide bandwidth when it is judged that a signal of the operating band 1 (2110 MHz to 2170 MHz) defined in the GPP specification is now being received, based on the status of a specification signal 90 of the receiving band. On the other hand, the controller 17 sets up the analog filters to have a narrow bandwidth when it is judged that a signal of the operating band 2 (1930 MHz to 1990 MHz) or operating band 3 (1805 MHz to 1880 MHz) is now being received, and compensates for the deterioration of the pass-band characteristic in the analog filters by using the digital filters located in the post stage. According to the sixth embodiment, the same effect as that of the first embodiment can be realized with the simpler configuration than that of the first embodiment.

FIG. 9 shows the seventh embodiment of a receiver according to the present invention. The reception system 56 has the same configuration as that of the second embodiment, except that the comparator 21 is removed.

The receiver of this embodiment is designed for the WCDMA cellular phone system defined in the GPP specification, like the sixth embodiment. When it is judged that a signal of the operating band 1 is now being received based on the status of the specification signal 90 of the receiving band, the controller 17 controls the gain of the gain control amplifiers 8 and 9 so that the second level detection signal 24 from the detector 20 keeps a predetermined level, like the case where there was no interference wave in the second embodiment.

When it is judged that the signal of the operating band 2 or 3 is now being received based on the status of the specification signal 90 of the receiving band, the controller 17 controls the gain of the gain control amplifiers 8 and 9 so that the second level detection signal 22 from the first detector 18 keeps a predetermined level, like the case where there was an interference wave in the second embodiment. According to the seventh embodiment, the same effect as that of the second embodiment can be realized by the simpler configuration than that of the second embodiment.

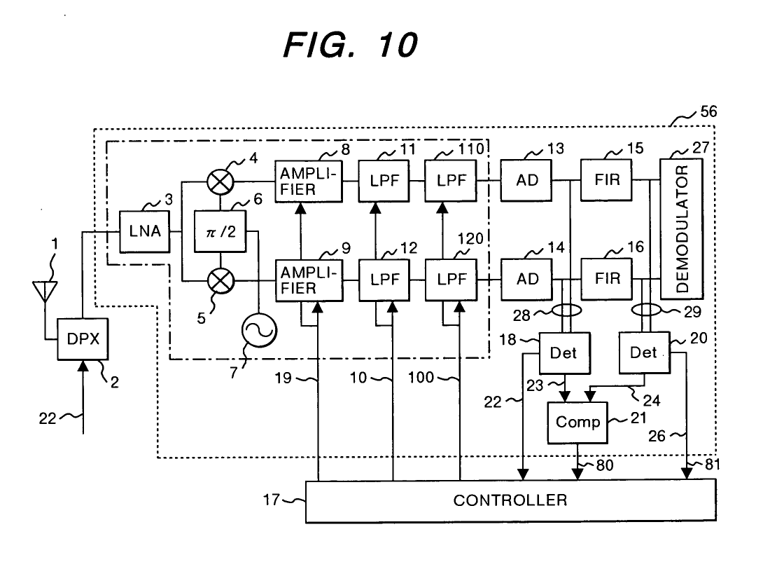

FIG. 10 shows the eighth embodiment of a receiver according to the present invention. In this embodiment, second analog filters 110 and 120 are connected, respectively, between the analog filters 11 and AD converter 13 and between the analog filters 12 and the AD converter 14 of the first embodiment. The pass-band characteristics of the second analog filters 110 and 120 are controlled variably in accordance with a control signal 100.

Normally, the cutoff frequency of the analog filters 11 and 12 is set to a wide bandwidth, like the first embodiment. During reception of an interference wave, e.g. narrow band blocking interference, at the adjacent frequency, the cutoff frequency of the analog filters is changed to a narrow bandwidth in accordance with the control signal 10 from the controller 17. In this embodiment, the deterioration of the baseband pass characteristic (flatness), which occurs when the cutoff frequency of the analog filters 11 and 12 is switched to a narrow bandwidth, can be compensated by changing the pass-band characteristics of the second analog filters 110 and 120 located in the post stage.

In the above-described embodiments, the filter controlling function and the gain controlling function are described separately. However, those two functions can be realized by a single receiver having the configuration shown in FIG. 1, for example, if the controller 17 executes Steps 105 to 108 of FIG. 2 after Step 204 of FIG. 4, and executes Steps 110 to 113 of FIG. 2 after Step 205 of FIG. 4.

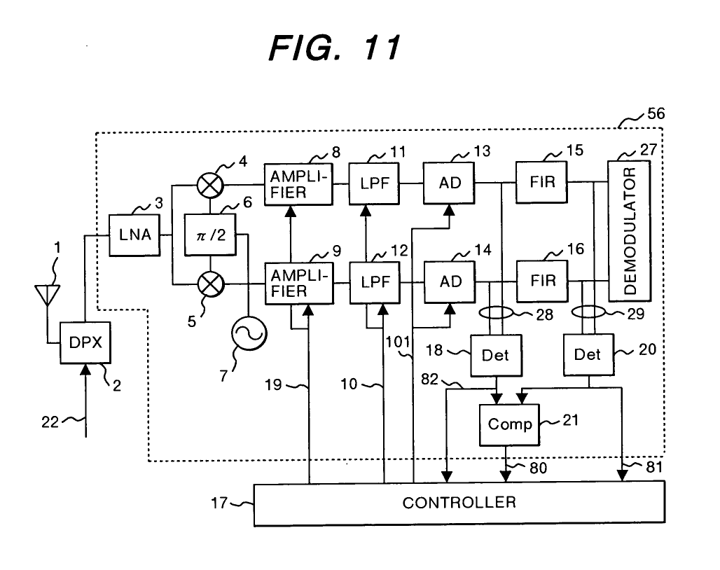

FIG. 11 shows the ninth embodiment of a receiver according to the present invention. Since the same reference numerals are applied for the same blocks as those described in the first embodiment, the explanation that overlaps the first embodiment will be omitted.

The controller 17 generates the gain control signal 19 for the variable gain amplifiers 8 and 9 according to a first level detection signal 82 or a second level detection signal 81. The controller 17 also generates a dynamic range control signal 101 for the AD converters 13 and 14 according to a comparator output signal 80.

Each of the AD converters 13 and 14 has a function for switching the dynamic range thereof. Normally, an AD converter having a narrow dynamic range can operate with low power consumption, but it is easy to saturate when the input level becomes large. On the other hand, an AD converter having a wide dynamic range operates with high power consumption, but it can operate without saturation even if the input level becomes large.

The narrow band blocking of the band 2 in the WCDMA acts as an interference wave whose offset frequency is 2.7 MHz, as described in the first embodiment, and it is difficult to fully suppress the interference wave with the analog filters having a normal level of cutoff frequency. Thus, there is possibility that the AD converters 13 and 14 are saturated by the effect of the narrow band blocking.

In order to prevent this saturation, according to the ninth embodiment, the dynamic range of the AD converters 13 and 14 is switched to a wide range in response to the control signal 101 when the output signal 30 of the comparator 21 indicates that the difference between the first and second level detection signals exceeds a predetermined value. Simultaneously with the switching of the dynamic range of the AD converters 13 and 14, the bandwidth of the analog filters described in the first embodiment may be switched. If necessary, the characteristic of the digital filters may be compensated.

According to the ninth embodiment, like the first embodiment, by setting the dynamic range of the AD converters 13 and 14 to a wide range when the interference wave near the desired signal frequency is received, the input level of the AD converters can be optimized and preferable reception characteristic is available. On the contrary, by setting the dynamic range of the AD converters 13 and 14 to a narrow range when no interference wave near the desired signal frequency is received, receiving operation with low power consumption can be realized.

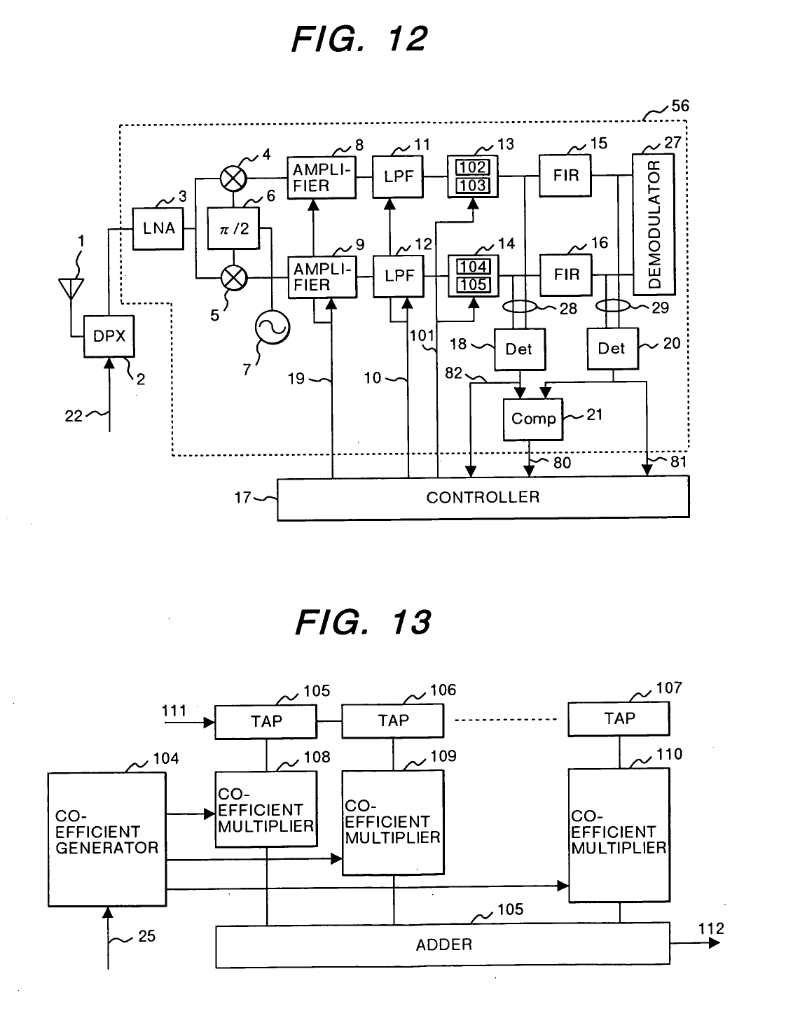

FIG. 12 shows the tenth embodiment of a receiver according to the present invention. Since the same reference numerals are applied for the same blocks as those described in the first embodiment, the explanation that overlaps the first embodiment will be omitted.

In the receiver of this embodiment, the AD converter 13 (14) is comprised of an AD converter 102 (104) having a narrow dynamic range and low power consumption, and an AD converter 103 (105) having a wide dynamic range. In the case where an interference wave that is difficult to be attenuated with the analog filters is input, like the case of narrow band blocking of band 2 according to the WCDMA, the AD converters 103 and 105 having the wide dynamic range are selected to obtain preferable reception characteristics. In the case where no interference wave is input, the AD converters 102 and 104 having the narrow dynamic range are selected to realize receiving operation with low power consumption.

Like the first and ninth embodiments, when the output signal 80 of the comparator 21 indicates that the difference between the first and second level detection signals exceeds a predetermined value, a suitable pair of the AD converters are selected among 102, 103, 104 and 105 in response to the control signal 101, so that AD converters 13 and 14 can have a wide dynamic range. Simultaneously with the selection of the AD converters, the bandwidth of the filters may be changed as described in the first embodiment.

Next, a method for controlling the pass-band characteristic for the digital filters described in the first embodiment will be explained specifically with reference to FIG. 13.

FIG. 13 shows an embodiment of a FIR filter applicable to the first to tenth embodiments of the invention. In order to control the bandwidth and band characteristic, the FIR filter is comprised of a plurality of coefficient multipliers 108, 109 and 110 connected to the output of a series of taps 105, 106 and 107, respectively. Each of the coefficient multipliers 108, 109 and 110 receives a coefficient value generated from a coefficient generator 104 according to the desired bandwidth or band characteristic, and outputs a product of the received coefficient value and the output from the corresponding tap to an adder circuit 105. The FIR filter can convert an input signal 111 supplied to the series of taps into an output signal 112. The coefficient generator 104 can generate variable coefficient values according to a control signal 25. By supplying a control signal corresponding to the desired bandwidth or band characteristic, FIR filter can derive from the adder circuit 105 an output signal 112 filtered with the desired bandwidth or band characteristic.

1. A high frequency signal receiver having a reception circuit and a controller, wherein said reception circuit comprises:
a variable gain amplifier for amplifying a received signal;
a first filter connected to said variable gain amplifier for restricting a bandwidth of an analog baseband signal;
an AD converter for converting an analog signal output from said first filter into a digital signal;
a second filter for restricting a bandwidth of a digital signal output from said AD converter; and
an interference wave detection circuit for detecting an interference wave that is included in said received signal and has a level equal to or greater than a predetermined level; and
said controller is configured to determine the level of said interference wave in said received signal based on an output signal of said interference wave detection circuit, control said first filter to operate with a predetermined bandwidth when said interference wave in said received signal is lower than a predetermined level, and control said first filter to have a narrow bandwidth when said interference wave in said received signal is equal to or greater than the predetermined level while changing a pass-band characteristic of said second filter so as to compensate for deterioration of a pass-band characteristic of said first filter.

2. A high frequency signal receiver having a reception circuit and a controller, wherein said reception circuit comprises:
a variable gain amplifier for amplifying a received signal;
a first filter connected to said variable gain amplifier for restricting a bandwidth of an analog baseband signal;
an AD converter for converting an analog signal output from said first filter into a digital signal;
a second filter for restricting a bandwidth of said digital signal output from said AD converter; and
an interference wave detection circuit for detecting an interference wave that is included in said received signal and has a level equal to or greater than a predetermined level; and
said controller is configured to determine the level of the interference wave in said received signal based on an output signal of said interference wave detection circuit, control the gain of said variable gain amplifier according to an output level of said second filter as a control target when the level of said interference wave in said received signal is lower than a predetermined level, and control the gain of said variable gain amplifier according to an output level of said AD converter as a control target when the level of said interference wave in said received signal is equal to or greater than the predetermined level.

3. The high frequency signal receiver according to claim 1, wherein said interference wave detection circuit comprises:
a first detection circuit for detecting an input signal level of said second filter; and
a second detection circuit for detecting an output signal level of said second filter; and
said controller is configured to determine the level of the interference wave in said received signal based on a result of comparison between output signals of said first and second detection circuits.

4. The high frequency signal receiver according to claim 1, wherein said interference wave detection circuit comprises:
a first detection circuit for detecting an input signal level of said second filter;
a second detection circuit for detecting an output signal level of said second filter; and
a comparator for comparing output signals of said first and second detection circuits to output a signal indicating whether a difference between signal levels of the compared signals is equal to or greater than a predetermined value; and
said controller is configured to determine a level of the interference wave in said received signal based on the output signal of said comparator.

5. The high frequency signal receiver according to claim 1, wherein said interference wave detection circuit further comprises a second reception circuit for receiving from another communication system a signal different from said received signal of said reception circuit; and
said controller is configured to determine the level of the interference wave in said received signal based on an output signal from said second reception circuit.

6. The high frequency signal receiver according to claim 5, wherein said reception circuit receives a signal for a WCDMA cellular phone system defined in 3GPP, and said second reception circuit receives a signal for a GSM cellular phone system.

7. A high frequency signal receiver for a WCDMA cellular phone system defined in 3GPP, said receiver having a reception circuit and a controller, and wherein said reception circuit comprises:
a variable gain amplifier for amplifying a received signal;
a first filter connected to said variable gain amplifier for restricting a bandwidth of an analog baseband signal;
an AD converter for converting an analog signal output from said first filter into a digital signal; and
a second filter for restricting a bandwidth of a digital signal output from said AD converter; and
said controller is configured to determine a target reception band based on a bandwidth specification signal given externally, control said first filter to operate in a predetermined bandwidth when the target reception band is operating band 1 in a range of 2110 MHz to 2170 MHz, control said first filter to have a narrow bandwidth when the reception band is operating band 2 in a range of 1930 MHz to 1990 MHz or operating band 3 in a range of 1805 MHz to 1880 MHz, and change a pass-band characteristic of said second filter so as to compensate for deterioration of a pass-band characteristic of said first filter.

8. A high frequency signal receiver for a WCDMA cellular phone system defined in 3GPP, said receiver having a reception circuit and a controller, wherein said reception circuit comprises:
a variable gain amplifier for amplifying a received signal;
a first filter connected to said variable gain amplifier for restricting a bandwidth of an analog baseband signal;
an AD converter for converting an analog signal output from said first filter into a digital signal; and
a second filter for restricting a bandwidth of a digital signal output from said AD converter; and
said controller is configured to determine a target reception band based on a bandwidth specification signal given externally, control the gain of said variable gain amplifier according to an output level of said second filter as a control target when the target reception band is operating band 1 in a range of 2110 MHz to 2170 MHz, and control the gain of said variable gain amplifier according to an output level of said AD converter as a control target when the reception band is operating band 2 in a range of 1930 MHz to 1990 MHz or operating band 3 in a range of 1805 MHz to 1880 MHz.

9. A high frequency signal receiver for receiving a high frequency signal and converting a frequency of the received signal into a baseband signal, said receiver comprising:
a first filter for restricting a bandwidth of a analog baseband signal;
a second filter for receiving an output signal of said first filter;
an AD converter for converting an analog signal output from said second filter into a digital signal;
a third filter for restricting a bandwidth of a digital signal output from said AD converter; and
detecting means for detecting an interference wave in the received signal, controlling said first filter to operate in a predetermined bandwidth when a level of the interference wave in the received signal is lower than a predetermined level, and controlling said first filter to have a narrow bandwidth when the level of the interference wave in the received signal is equal to or greater than the predetermined level, while changing a pass-band characteristic of said second filter to compensate for deterioration of a pass-band characteristic of said first filter.

10. A semiconductor integrated circuit comprising:
a low noise amplifier for amplifying a received high frequency signal;
a pair of mixers for I-phase (Inphase) and Q-phase (Quadraphase) each connected to said low noise amplifier;
a 90-degree phase shifter for outputting two series of oscillation signals for I-phase and Q-phase from an output signal of an oscillator, and supplying said mixers with the oscillation signals, respectively;
variable gain amplifiers for I-phase and Q-phase connected to said mixers, respectively; and
a pair of analog filters for I-phase and Q-phase connected to said variable gain amplifiers, respectively; and wherein
each of said analog filters is configured to have a wide bandwidth for passing a baseband signal in a desired wave with a flat characteristic or a narrow bandwidth for suppressing an interference wave near the desired wave in accordance with a control signal given externally.

11. The semiconductor integrated circuit according to claim 10, further comprising a pair of second analog filters for I-phase and Q-phase located in a post stage of said pair of analog filters, said second analog filters compensating for deterioration of a pass-band characteristic which occurs when each of said analog filters is changed to have a narrow bandwidth.

12. A high frequency signal receiver having a reception circuit and a controller, wherein said reception circuit comprises:
a variable gain amplifier for amplifying a received signal;
a first filter connected to said variable gain amplifier for restricting a bandwidth of an analog baseband signal;
an AD converter for converting an analog signal output from said first filter into a digital signal;
a second filter for restricting a bandwidth of a digital signal output from said AD converter; and
an interference wave detection circuit for detecting an interference wave that is included in said received signal and has a level equal to greater than a predetermined level; and
said controller is configured to determine the level of the interference wave in said received signal based on an output signal of said interference wave detection circuit, control said AD converter to operate in a predetermined dynamic range when the level of the interference wave included in the received signal is lower than the predetermined level, and control said AD converter to have a wide dynamic range when the level of the interference wave in the received signal is equal to or greater than the predetermined level.

13. A high frequency signal receiver having a reception circuit and a controller, wherein said reception circuit comprises:
a variable gain amplifier for amplifying a received signal;
a first filter connected to said variable gain amplifier for restricting a bandwidth of an analog baseband signal;
an AD converter for converting an analog signal output from said first filter into a digital signal;
a second filter for restricting a bandwidth of a digital signal output from said AD converter; and
an interference wave detection circuit for detecting an interference wave that is included in said received signal and has a level equal to or greater than a predetermined level; and
said controller is configured to determine the level of the interference wave in the received signal based on an output signal of said interference wave detection circuit, control said first filter to operate in a predetermined bandwidth and said AD converter to operate in a predetermined dynamic range when the level of the interference wave in the received signal is lower than the predetermined level, and control said first filter to have a narrower bandwidth, said AD converter to have a wider dynamic range and a pass-band characteristic so that deterioration of a pass-band characteristic of said first filter is compensated when the level of the interference wave in the received signal is equal to or greater than the predetermined level.

14. A high frequency signal receiver having a reception circuit and a controller, wherein said reception circuit comprises:
a variable gain amplifier for amplifying a received signal;
a first filter connected to said variable gain amplifier for restricting a bandwidth of an analog baseband signal;
an AD converter for converting an analog signal output from said first filter into a digital signal and including a first AD converter having a wide dynamic range and a second AD converter having a narrow dynamic range;
a second filter for restricting a bandwidth of the digital signal output from said AD converter; and
an interference wave detection circuit for detecting an interference wave that is included in the received signal and has a level equal to or greater than a predetermined level; and
said controller is configured to determine the level of an interference wave in the received signal based on an output signal of said interference wave detection circuit, control said AD converter so that said first AD converter having the wide dynamic range is operative when the level of the interference wave in the received signal is lower than the predetermined level, and control said AD converter so that said second AD converter having the narrow dynamic range is operative when the level of the interference wave in the received signal is equal to or greater than the predetermined level.

15. The high frequency signal receiver according to claim 1, wherein said second filter is comprised of a FIR filter having a plurality of variable tap coefficients for changing pass-band characteristic thereof.
